(19) United States
(12) Patent Application Publication
(10) Pub. No.: US 2013/0073749 A1
(43) Pub. Date: Mar. 21, 2013

(54) BACKCHANNEL COMMUNICATION BETWEEN HOST AND INTERFACE MODULE

(71) Applicants: Francois Tremblay, Gatineau (CA); Wes D'Haene, Airdrie (CA); Ryan Latchman, Irvine, CA (US)

(72) Inventors: Francois Tremblay, Gatineau (CA); Wes D'Haene, Airdrie (CA); Ryan Latchman, Irvine, CA (US)

(21) Appl. No.: 13/580,397

(22) PCT Filed: Feb. 22, 2011
(86) PCT No.: PCT/CA2011/050108

§ 371 Date: Dec. 4, 2012

Related U.S. Application Data
(60) Provisional application No. 61/306,615, filed on Feb. 22, 2010.

(51) Int. Cl. G06F 13/14

(52) U.S. Cl. 710/16

(57) ABSTRACT

A receiving element for receiving data over an electrical high speed serial data channel, the receiving element monitoring characteristics of the data received over the high speed serial data channel and providing feedback on the monitored characteristics over a low speed digital interface. A transmitting element receiving feedback over a low speed digital interface and transmitting data over an electrical high speed serial data channel in dependence on the received feedback.

### CROSS-REFERENCE TO RELATED APPLICATIONS

This application claims the benefit of and priority to U.S. Patent Application No. 61/306,615 filed 22 Feb. 2010 under the title BACKCHANNEL COMMUNICATION BETWEEN HOST AND INTERFACE MODULE.

The content of the above patent application is hereby expressly incorporated by reference into the detailed description hereof.

### BACKGROUND OF THE INVENTION

The present document relates to devices and methods that facilitate communication between a host and an interface module.

### BRIEF SUMMARY OF THE INVENTION

This application is directed to a backchannel communication system between a host and an interface module. In a first aspect, the invention provides a receiving element for receiving data over an electrical high speed serial data channel, the receiving element monitoring characteristics of the data received over the electrical high speed serial data channel and providing feedback on the monitored characteristics over a low speed digital interface.

In another aspect, the electrical high speed serial data channel comprises one of the following: a 100 Gigabit Ethernet link, a 40 Gigabit Ethernet link, an FDR Infiniband link, or an EDR Infiniband link.

In a further aspect, the monitored characteristics of the received data include one or more of the following: phase jitter, inner eye amplitude, outer eye amplitude, eye width, jitter histogram, and margins for each of these characteristics.

In a further aspect, the feedback provided includes information on one or more of the following: temperature information, voltage information, and optical power information.

In a further aspect, the receiving element further comprises an eye monitor used to monitor the characteristics of the received data.

In a further aspect, the low speed digital interface comprises one of the following: an inter-integrated circuit interface, a serial peripheral interface, or a management data input/output interface.

In a further aspect, the invention provides a transmitting element receiving feedback over a low speed digital channel and transmitting data over an electrical high speed serial data channel in dependence on the received feedback.

In a further aspect, the feedback is used to adjust one or more of the following characteristics of the transmitted data: clocked transmit de-emphasis, clocked transmit pre-emphasis, non-clocked transmit de-emphasis, and non-clocked transmit pre-emphasis.

In a further aspect, the feedback is used to adjust the launch amplitude of the transmitted data.

In a further aspect, the transmitting element further comprises at least one pre-equalization element used to pre-equalize the transmitted signal, wherein the pre-equalization element is activated or deactivated based on the received feedback.

In a further aspect, the invention provides the receiving element in combination with the transmitting element.

In a further aspect, either the receiving element or the transmitting element comprises an interface module adapted to communicate with a remote communication link, the other element comprises a host module, and the interface module relays data between the remote communication link and the electrical high speed serial data channel.

In a further aspect, the electrical high speed serial data channel is an electronic link and the remote communication link is an optical link, the interface module further comprising an optical transmit section for converting received electrical signals to optical signals and an optical receive section for converting received optical signals to electronic signals.

In a further aspect, the electrical high speed serial data channel is connected to the interface module by a plug connector.

In a further aspect, the host module comprises a parallel data channel, an application-specific integrated circuit (ASIC) that receives and transmits parallel data over the parallel data channel, and a serializer/deserializer unit for serializing data received from the ASIC over the parallel data channel for transmission over the electrical high speed serial data channel and for deserializing data received over the electrical high speed serial data channel for transmission to the ASIC over the parallel data channel.

In a further aspect, the invention provides a method for optimizing communication over a high-speed serial data link, comprising the steps of receiving data over an electrical high speed serial data channel at a receiving element, monitoring data characteristics of the data received over the electrical high speed serial data channel, and providing feedback on the monitored characteristics over a low speed digital interface.

In a further aspect, the method further comprises the steps of receiving the feedback over the low speed digital channel at a transmitting element, and transmitting data over the electrical high speed serial data channel in dependence on the received feedback.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

FIG. 1 is a block diagram representation of an example of a pluggable interface module connecting a host to a transmission medium.

FIG. 2 is a flow chart showing an example transmitting element responding to feedback from a receiving element.

FIG. 3 is a flow chart showing a second example transmitting element responding to feedback from a receiving element.

FIG. 4 is an eye diagram showing characteristics of a received signal monitored by an example receiving element.

FIG. 5 is an eye diagram showing further characteristics of a received signal monitored by an example receiving element.

### DETAILED DESCRIPTION OF EXAMPLE EMBODIMENTS

In high speed data networks a host network element such as a switch or router (also referred to as a host) can be connected to a transmission medium (for example fibre cable, copper cable or other physical medium) through an interface module that processes data coming in from the transmission medium to place it into a condition suitable for the host and that processes data from the host to place it into a condition suitable for the transmission medium. By way of example, in an Ethernet network a pluggable transceiver interface module can be used to convert data received as electrical signals from a host into optical data for transmission over optical fibre and to convert data received as optical signals from optical fibre into electrical signals for application to the host. The interface module is pluggable in that connection of the interface module to the host channel occurs through a pluggable connector. In lower data speed systems, the transmission characters of the host channel are typically such that a wide range of data quality over the host channel can be tolerated. However, in higher data speed systems the margin for error is lower due to the shorter time period for each symbol.

Accordingly, example embodiments described herein relate to improving the quality of data exchange over the host channel between a host and an interface module such as a transceiver interface module. In some implementations, the example embodiments described herein may either facilitate optimization of high speed characteristics or improve power consumption related to the transmission of data over the data channel, or both.

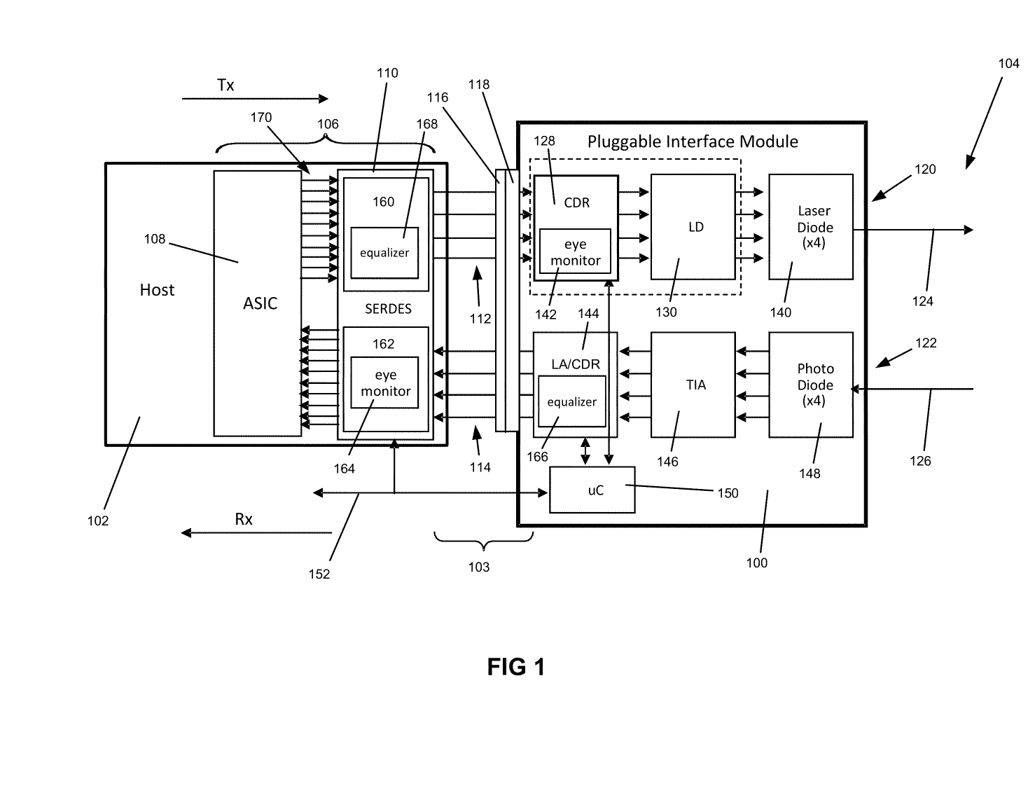

Example embodiments will now be described with reference to FIG. 1 which illustrates a host 102 that is connected through a host channel 103 to a pluggable network transceiver interface module 100, which in turn is connected to a transmission medium 104. In the illustrated embodiment, the transmission medium 104 includes fibre optic cable 124 for transmitting high speed data from the interface module 100 and fibre optic cable 126 for transmitting high speed data to the interface module 100, however embodiments described herein can also be applied to non-fibre transmission mediums such as copper for example. In the illustrated embodiment, the host 102 includes a network interface card or board 106 that allows data to be exchanged between the host 102 and the network interface module 100. In at least one example embodiment, the host interface board 106 includes data processing circuitry, which could for example be implemented an ASIC 108 (“Application Specific Integrated Circuit”), and a SERDES (“SERializer-DESerializer”) chip or module 110. SERDES module 110 receives parallel data from the host ASIC 108 over a parallel data channel 170 and converts it into high speed serial data for transmission over the host channel 103 to the network interface module 100, and receives high speed serial data from the network interface module 100 through the host channel 103 which it then converts into parallel data and passes on to the ASIC 108 over the parallel data channel 170.

In an example embodiment, the host channel 103 includes one or more physical conductors 112 for transmitting high speed data to the interface module 100 and one or more physical conductors 114 for receiving high speed data from the interface module. In some embodiments, each conductor in the transmitting conductors 112 and receiving conductors 114 operates as a separate data channel. The conductors 112, 114 terminate at a plug connector 116 that releasably couples with a corresponding plug connector 118 of the interface module 100.

In the illustrated embodiment, the pluggable transceiver module 100 includes a transmit section 120 and a receive section 122 for processing outgoing and incoming high speed data respectively. The transmit section 120 includes a CDR (“Clock and Data Recovery Module”) module 128, an LD (“Laser Driver”) module 130 and a laser diode module 140. The CDR module 128 performs clock and data recovery on the high speed data stream received through connector 118 from the host channel 103, and LD module 130 and laser diode module 140 modulate the resulting high speed data stream onto fibre optic cable 124. In embodiments having multiple channels in the form of multiple receiving conductors 114, the CDR module 128 performs these operations for each channel of the conductors 114.

The receive section 122 includes a photo diode module 148, a TIA (“TransImpedance Amplifier”) module 146 and a LA/CDR (“Limiting Amplifier/Clock and Data Recovery”) module 144. The photo diode module 148 receives high speed optical data from fibre optic cable 126 and converts the optical data into high speed electrical data that is further converted from current signals into voltage signals by TIA module 146. The high speed data from the TIA module 146 is processed by LA/CDR module 144 and then sent over host channel 103 as high speed serial data to a receiver portion of SERDES 110. In embodiments having multiple channels in the form of multiple transmitting conductors 112, the LA/CDR module 144 performs these operations for each channel of the conductors 112.

In example embodiments a low speed digital connection or interface 152 is provided between host SERDES 110 and the interface module 100 to allow back channel communications between transmitting elements of the SERDES module 110 and corresponding receiving elements of the interface module 100 and between transmitting elements of the interface module 100 and receiving components of the SERDES Module 110. In some implementations, the interface module 100 includes a uC (microcontroller) module 150 that facilitates communications over the low speed digital interface 152. By way of non-limiting example, the low speed digital interface 152 could include an I2C (“Inter-Integrated Circuit”) interface, or SPI (“Serial Peripheral Interface”), MDIO (“Management Data Input/Output”) interface, or similar interface. In some example embodiments, the low speed data connection 152 is used for data rates under 10 MB/s.

In example embodiments, the CDR module 128 includes an eye monitor 142 for monitoring the eye characteristics of the high speed data that is received by CDR module 128 over the host channel 103 from SERDES module 110. For example, eye monitor 142 can monitor jitter, inner eye amplitude, outer eye amplitude, a jitter histogram, and margins for each of these characteristics. The monitored eye characteristics can be fed back through the low speed digital interface 152 to a serializer section 160 of the SERDES module 110, and used by the serializer section 160 to adjust data transmission parameters in order to bring the eye characteristics being measured at the CDR eye monitor 142 to within predetermined target eye characteristics. Accordingly, in at least some implementations, eye characteristics measured at the CDR module 128 can be transmitted through a low data speed backchannel in the form of low speed digital interface 152, and then used by the SERDES module 110 to optimize high speed data transmission performance over the host channel 103. For example, some embodiments may use the eye characteristics measured at the CDR eye monitor 142 to modify the transmit equalization parameters used by the SERDES module 110 in order to achieve predetermined target eye characteristics as measured at the CDR eye monitor 142. This transmit pre-equalization may include transmit de-emphasis and/or pre-emphasis, with or without the use of a clock signal, to compensate for signal losses over the host channel 103.

For example, transmit de-emphasis may be used to de-emphasize each bit except for the first bit after a transition, thereby making the high-frequency information conveyed by the bit transition more salient and compensating for high-frequency signal loss over the host channel 103.

Similarly, low speed digital interface 152 can also be used to optimize high speed data that is being transmitted from the interface module 100 to host SERDES module 110. In this regard, in an example embodiment, the deserializer section 162 of SERDES module 110 includes an eye monitor 164 for monitoring the eye characteristics of the high speed data that is received by the SERDES module 110 over the host channel 103 from interface module 100. For example, SERDES eye monitor 164 can monitor jitter, inner eye amplitude, outer eye amplitude, a jitter histogram, and margins for each of these characteristics. The monitored eye characteristics can be fed back through the low speed digital interface 152 to the LA/CDR module 144 of the interface module 100, and used by LA/CDR module 144 to adjust data transmission parameters in order to bring the eye characteristics being measured at the SERDES eye monitor 164 to within predetermined target eye characteristics. Accordingly, in at least some implementations, eye characteristics at measured at the SERDES module 110 can be transmitted through a low data speed backchannel and then used by the interface module 100 to optimize high speed data transmission performance over the host channel 103.

Accordingly, the system of FIG. 1 provides a backchannel using a low speed interface to set the operating parameters of the serializer section 160 of SERDES module 110 and the operating parameters of the LA/CDR module 144 of the transceiver interface module 100. In some applications, this allows the operating parameters to be change over time which may in turn facilitate adaptive optimization of high data speed transmission characteristics and power consumption used for the communications link. For example, some embodiments may optimize power consumption used for the communications link by reducing the launch amplitude of the signals transmitted across the host channel 103. By monitoring the eye characteristics of the signal at the SERDES eye monitor 164 and the CDR eye monitor 142 and modifying the transmit equalization parameters used by the LA/CDR module 144 and the serializer section 160 of the SERDES module 110, respectively, the predetermined target eye characteristics can be maintained through transmit equalization even while launch amplitude is decreased. Some embodiments may also optimize power consumption by deactivating the circuits that perform transmit equalization when the monitored eye characteristics indicate that pre-equalization is unnecessary for maintaining the predetermined target eye characteristics.

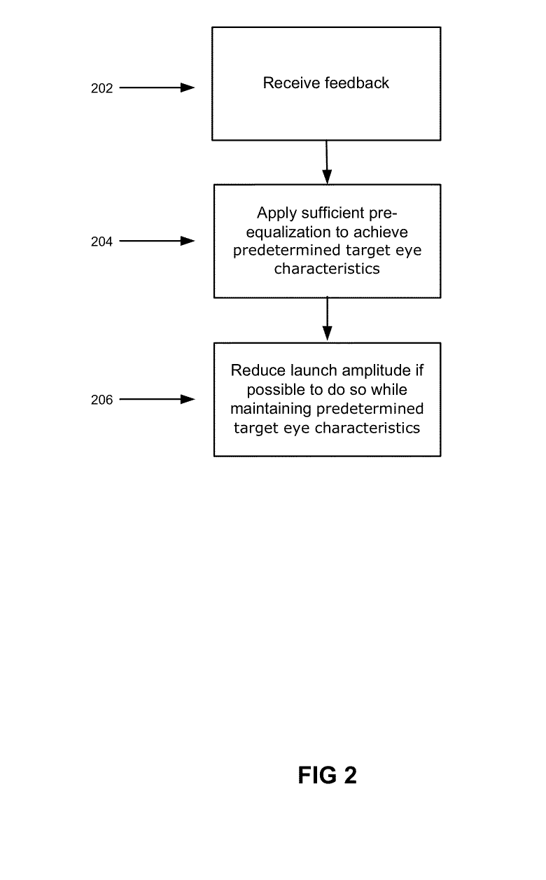

With reference to the drawings, FIG. 2 is a flow chart of the operation of an example embodiment, wherein the LA/CDR unit 144 in conjunction with the microcontroller 150 performs pre-equalization and optimizes power consumption of the transmission over host channel 103 via physical conductors 114 based on the feedback received from the SERDES module 110 via the low-speed digital interface 152. In FIG. 2, the operational flow of the LA/CDR unit 144 and the microcontroller 150 begins at step 202 when the microcontroller receives feedback via the low speed digital interface 152. At step 204, the microcontroller 150 instructs the LA/CDR unit 144 to equalize its transmitted data signal in response to the feedback, applying sufficient transmit pre-emphasis and other pre-equalization effects to the transmitted data signal to achieve predetermined target eye characteristics at the SERDES module 110. Once the feedback from the SERDES module 110 indicates that the predetermined target eye characteristics have been achieved, the microcontroller 150 at step 206 instructs the LA/CDR unit 144 to begin reducing the launch amplitude of the transmitted data signal as much as it can without letting the received signal at the SERDES module 110 fall short of the predetermined target eye characteristics. The process is iterative, with feedback being monitored at step 202 and equalization being adjusted at step 204 while the launch amplitude is being reduced at step 206. In alternative embodiments, the process may operate according to a different sequence of steps while achieving the same result, namely the optimization of signal quality and power consumption over the host channel 103.

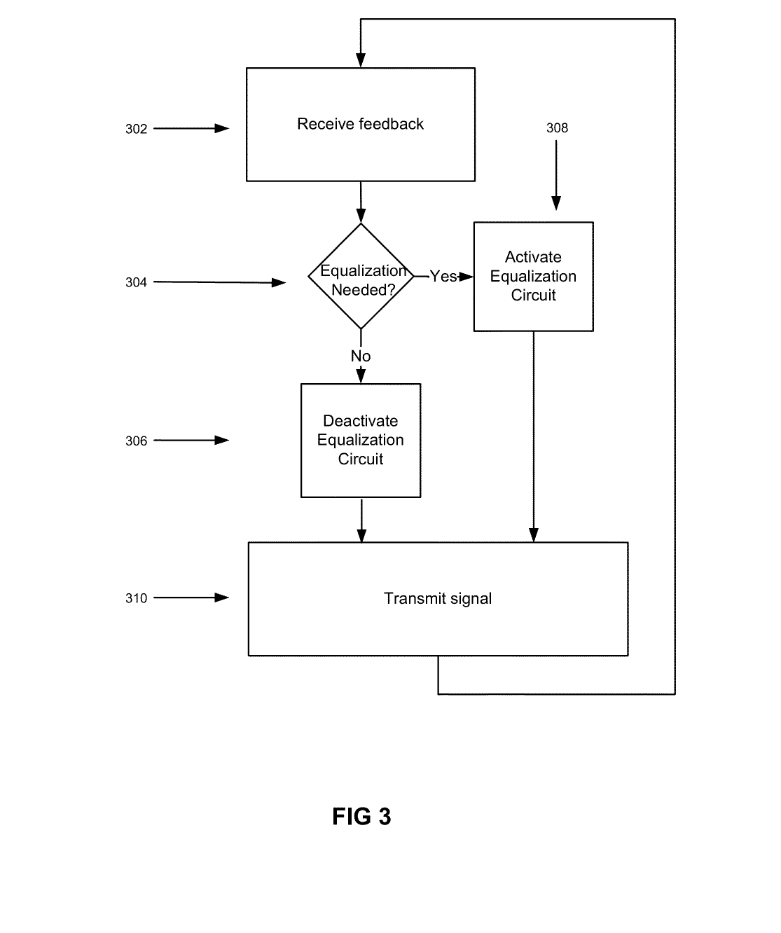

FIG. 3 is a flow chart of another example embodiment, wherein the LA/CDR unit 144 includes at least one sub-component pre-equalization circuit 166 which can be activated to perform transmit de-emphasis or another pre-equalization function, but which can be deactivated to reduce power consumption. At step 302, the microcontroller 150 receives feedback via the low speed digital interface 152. At step 304, the microcontroller 150 determines whether equalization needs to be applied to the transmitted data signal based on whether the predetermined target eye characteristics are exhibited at the SERDES module 110. If equalization is deemed to be necessary at step 304, the microcontroller 150 proceeds to step 308, wherein the equalization sub-component circuit of the LA/CDR unit 144 is activated, applying sufficient transmit pre-emphasis and other pre-equalization effects to the transmitted data signal to achieve the predetermined target eye characteristics at the SERDES module 110. However, if equalization is deemed to be unnecessary at step 304 because the predetermined target eye characteristics are already being exhibited or exceeded at the SERDES module 110, the microcontroller 150 proceeds to step 306, deactivating the equalization sub-component circuit to reduce power consumption. From either step 308 or 306, the system proceeds to step 310, wherein the data signal is transmitted to the deserializer portion 164 of the SERDES module 110, thereby generating new feedback from the SERDES module 110 and restarting the adaptive operation of the process at step 302.

The processes illustrated in FIG. 2 and FIG. 3 may also be carried out in the opposite direction, i.e. to pre-equalize the signal being transmitted from the host to the interface module. Instead of using the pre-equalization circuit 166 of the LA/CDR unit 144 to modify the signal, the host uses a pre-equalization circuit 168 in the serializer section 160 of the SERDES module 110 to modify the signal in response to feedback from the CDR eye monitor 142 sent over the low speed digital interface 152.

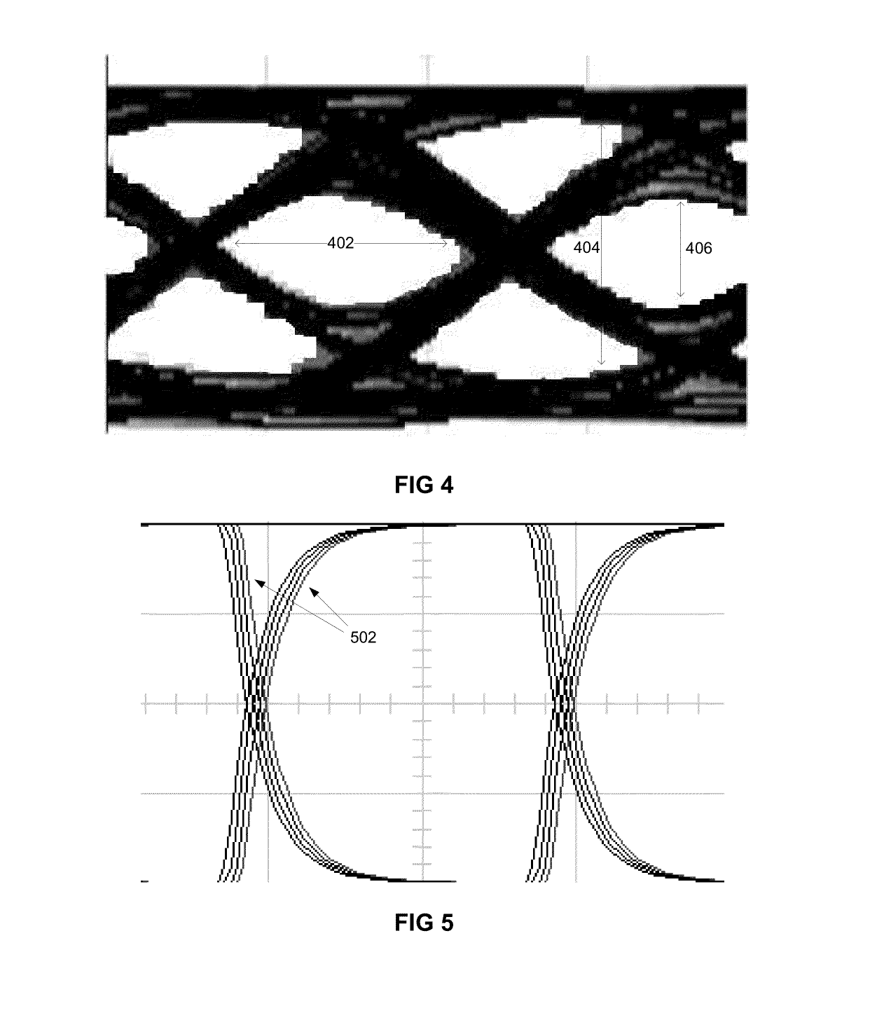

A unit receiving a signal over the host channel 103 may monitor several different characteristics of the received signal. FIG. 4 is an eye diagram illustrating characteristics of a signal received over a high speed serial data channel that could be monitored by an example interface module 100 or SERDES module 110. The eye width 402 measures the horizontal eye opening, shortened from the ideal of 1 UI (unit interval) due to jitter. The outer eye height 404 is a measure of the difference between steady-state ones (high signal level), and steady-state zeroes (low signal level). The inner eye height 406 measures deviation from the ideal outer eye height (i.e. vertical eye closure), and is indicative of the attenuation and noise of the signal in the middle of a symbol. FIG. 5 is a cleaner eye diagram of a received signal, wherein phase jitter 502 is visibly indicated by the multiple overlapping lines near the symbol boundary. By measuring the jitter 502 exhibited at different frequencies, a jitter histogram can be created. Any of these characteristics, or the marginal values of these characteristics relative to previous measurements, may be used as the basis for the feedback data transmitted over the low speed digital interface 152.

In some example embodiments, the system shown in FIG. 1 may be used to support high speed data exchange for 100 Gigabits Ethernet or similar network protocols. In some example embodiments, the system shown in FIG. 1 may be used to support high speed data exchange for 40 Gigabit Ethernet, FDR Infiniband, or EDR Infiniband. The transmission medium 104 used for the remote link is in some example embodiments an optical link, such as a 32G Fibre Channel or an OC-768 compliant link, although in other example embodiments it may be an electrical link such as 100 Gigabit Ethernet, 40 Gigabit Ethernet, FDR Infiniband, or EDR Infiniband.

In some example embodiments, the interface module 100 includes a printed circuit board to which the CDR module 128, LD module 130, laser diode module 140, photo diode module 148, TIA module 146. LA/CDR module 144 and uC module 150 are each mounted. At least some the modules mounted to the printed circuit board may be implemented as monolithic integrated circuits on respective silicon chips, including for example CDR module 126 and LA/CDR module 144.

SERDES module 110 may also be implemented, in some example embodiments, as a monolithic integrated circuit on a silicon chip mounted to network interface board 106.

Although the above embodiments are described as using a CDR module and SERDES module at respective ends of the host channel 103, other embodiments may replace or supplement one or both of these modules with a retimer, limiting amplifier, re-driver, and/or other component that performs the same function.

In the pluggable interface module 100 shown in FIG. 1, the uC module 150 controls communications over the low speed data channel 152 that is used for backchannel communications. In at least some applications the uC module 150 and low speed digital interface 152 provide additional functionality in that they may also be used for monitoring and providing low speed diagnostic information such as temperature information, voltage information, optical power information. In some example embodiments, separate low speed digital interfaces could be provided between CDR 128 and the serializer section 160 and between deserializer section 162 and LA/CDR module 144.

In the example embodiments described above, the data channel used to provide feedback has been described as a low speed digital interface 152 operating over a separate physical medium from the host channel 103. However, alternative embodiments may vary the characteristics of this channel, including designs wherein feedback is communicated over the same physical medium as the host channel 103, creating a virtual backchannel medium over the high speed serial data channel using techniques such as time- or frequency-division multiplexing.

Example implementations of a virtual backchannel medium are described in U.S. Patent Application publication number 2010/0043045.

The embodiments presented above are not limited to any specific network protocol or application. The host channel 103 may be embodied as an electrical link of varying length, from one inch to hundreds of metres long. Furthermore, while the embodiments presented above describe the transmitting and receiving portions of the SERDES module, or the transmitting and receiving portions of the interface module, as being housed together on a single piece of hardware, alternative embodiments may house the transmitting and receiving portions of these modules on separate physical components.

The various embodiments presented above are merely examples and are in no way meant to limit the scope of this disclosure. Variations of the innovations described herein will be apparent to persons of ordinary skill in the art, such variations being within the intended scope of the present application. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A receiving element for receiving data over an electrical high speed serial data channel, the receiving element monitoring characteristics of the data received over the electrical high speed serial data channel and providing feedback on the monitored characteristics over a low speed digital interface.

2. The receiving element of claim 1 wherein the electrical high speed serial data channel comprises one of the following: a 100 Gigabit Ethernet link, a 40 Gigabit Ethernet link, an FDR Infiniband link, or an EDR Infiniband link.

3. The receiving element of claim 1 wherein the monitored characteristics of the received data include one or more of the following:
phase jitter, inner eye amplitude, outer eye amplitude, eye width, jitter histogram, and margins for each of these characteristics.

4. The receiving element of claim 1, wherein the feedback provided includes information on one or more of the following:
temperature information, voltage information, and optical power information.

5. The receiving element of claim 1, further comprising an eye monitor used to monitor the characteristics of the received data.

6. The receiving element of claim 1, wherein the low speed digital interface comprises one of the following: an inter-integrated circuit interface, a serial peripheral interface, or a management data input/output interface.

7. The receiving element of claim 1 in combination with a transmitting element, the transmitting element receiving the feedback on the monitored characteristics over the low speed digital interface and transmitting data over the electrical high speed serial data channel in dependence on the received feedback.

8. The system of claim 7, wherein the feedback is used to adjust one or more of the following characteristics of the transmitted data: clocked transmit de-emphasis, clocked transmit pre-emphasis, non-clocked transmit de-emphasis, and non-clocked transmit pre-emphasis.

9. The system of claim 7, wherein the feedback is used to adjust the launch amplitude of the transmitted data.

10. The system of claim 7, further comprising at least one pre-equalization element used to pre-equalize the transmitted signal, wherein the pre-equalization element is activated or deactivated based on the received feedback.

11. The system of claim 7, wherein:
either the receiving element or the transmitting element comprises an interface module adapted to communicate with a remote communication link;
the other element comprises a host module; and
the interface module relays data between the remote communication link and the electrical high speed serial data channel.

12. The system of claim 11, wherein the remote communication link is an optical link, further comprising an optical transmit section for converting received electrical signals to optical signals and an optical receive section for converting received optical signals to electrical signals.

13. The system of claim 11 wherein the electrical high speed serial data channel is connected to the interface module by a plug connector.

14. The system of claim 11 wherein the host module comprises:
a parallel data channel;
an application-specific integrated circuit (ASIC) that receives and transmits parallel data over the parallel data channel; and
a serializer/deserializer unit for serializing data received from the ASIC over the parallel data channel for transmission over the electrical high speed serial data channel and for deserializing data received over the electrical high speed serial data channel for transmission to the ASIC over the parallel data channel.

15. A transmitting element receiving feedback over a low speed digital channel and transmitting data over an electrical high speed serial data channel in dependence on the received feedback.

16. The transmitting element of claim 15, wherein the feedback is used to adjust one or more of the following characteristics of the transmitted data: clocked transmit de-emphasis, clocked transmit pre-emphasis, non-clocked transmit de-emphasis, and non-clocked transmit pre-emphasis.

17. The transmitting element of claim 15, wherein the feedback is used to adjust the launch amplitude of the transmitted data.

18. The transmitting element of claim 15, further comprising at least one pre-equalization element used to pre-equalize the transmitted signal, wherein the pre-equalization element is activated or deactivated based on the received feedback.

19. A method for optimizing communication over an electrical high-speed serial data link, comprising the steps of:
receiving data over the electrical high speed serial data channel at a receiving element;
monitoring data characteristics of the data received over the electrical high speed serial data channel; and
providing feedback on the monitored characteristics over a low speed digital interface.

20. The method of claim 19, further comprising the steps of:
receiving the feedback over the low speed digital channel at a transmitting element; and
transmitting data over the electrical high speed serial data channel in dependence on the received feedback.

21. An interface module comprising:
a receiving element for receiving data over a first electrical high speed serial data channel from a serial data transmitter, the receiving element monitoring one or more characteristics of the data received over the first electrical high speed serial data channel and providing feedback in dependence on the one or more monitored characteristics to the serial data transmitter over a low speed digital interface; and
a transmitting element for transmitting data over a second electrical high speed serial data channel to a serial data receiver, the transmitting element receiving low speed digital data feedback from the serial data receiver and adjusting one or more characteristics of the transmitted data in dependence on the received feedback.

22. The interface module of claim 21 wherein the first and second electrical high speed serial data channels convey data as electrical signals.

23. The interface module of claim 21 wherein the low speed digital data feedback received by the transmitting element is received over the low speed digital interface.

24. The interface module of claim 23 comprising a microcontroller, the microcontroller being connected to the low speed digital interface and each of the receiving element and the transmitting element, the microcontroller being configured to provide the feedback to the serial data transmitter over the low speed digital interface and to control the operation of the transmitting element in dependence on the received feedback.

25. The interface module of claim 21 wherein the low speed digital interface comprises a dedicated physical conductor.

26. The interface module of claim 21 comprising a common pluggable connector for electrically connecting the interface module to the first and second high speed data channels and the low speed digital interface.

27. The interface module of claim 21 wherein the low speed digital interface comprises shared use of the first electrical high speed serial data channel for transmitting the feedback back to the serial data transmitter.

28. The interface module of claim 21 wherein the receiving element comprises a clock and data recovery circuit for processing the received data and the interface module comprises an laser driver and laser diode for modulating the processed received data onto an optical fiber link.

29. The interface module of claim 21 comprising an optical receiver for receiving optical data from an optical fibre connection and converting the optical data into electrical signals, the transmitting element comprising a limiting amplifier and clock data recover circuit for converting the electrical signals from the optical receiver into the data for transmitting over the second electrical high speed serial data channel.
